(19) United States
(12) Patent Application Publication
(10) Pub. No.: US 2003/0051726 A1
(43) Pub. Date: Mar. 20, 2003

(54) Process for the oxidation of starch

(76) Inventors: Stefan Leininger, Hanau (DE); Thomas Haas, Frankfurt (DE); Dietmar Bischoff, Segnitz (DE); Rudolf Vanheertum, Brasschaat (BE); Armin Ecker, Rodenbach (DE)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/247,116

(22) Filed: Sep. 19, 2002

(30) Foreign Application Priority Data
Sep. 19, 2001 (DE) 101 46 069.4

(51) Int. Cl. C08B 31/18

(52) U.S. Cl. 127/71; 536/105

(57) ABSTRACT

A process for the oxidation of starch to obtain carbonyl-substituted starch using V, Cr, Mn, Fe, Co or Cu, wherein Fe and/or Cu are preferred as catalyst. The oxidation of the starch proceeds in quasi-dry form by spraying the dry starch with solutions containing hydrogen peroxide and/or the catalyst and mixing the moistened powder. Oxidized starch containing up to approx. 10 carbonyl groups per 100 glucose units is obtainable.

### INTRODUCTION AND BACKGROUND

The present invention relates to a process for the oxidation of starch to obtain carbonyl-substituted starch by treating the starch with hydrogen peroxide in the presence of a metal ion catalyst.

Starch is a renewable raw material which, depending upon origin, consists of a mixture of different polysaccharides. The primary constituents are amylose, in which glucose units are linked together by α-1,4-glycoside bonds, and amylopectin, which is likewise a polymer of glucose units, but additionally contains α-1,6-glycoside bonds. Due to its granular structure and high molecular weight, starch is insoluble in cold water. However, on heating, the starch granules swell, increasing in hydrodynamic radius. The breakdown of the granular structure at the gelatinization point results in a dramatic increase in viscosity, which declines again at higher temperatures when the hydrogen bridge bonds dissociate. Starch may be modified in many different ways, resulting in changes to chemical and physical properties and so opening up new applications to the modified starches.

Oxidation of starches is a chemical modification, wherein, by selection of the oxidizing agent and the oxidizing conditions, it is possible to vary the degree of oxidation, the degree of degradation and the regioselectivity of the starch.

By oxidizing starch with gaseous nitrogen dioxide, it is possible to convert the primary alcohol groups of the polysaccharide into carboxyl groups, wherein a degree of conversion of up to 90% is possible, c.f. DE 44 264 43 A1. The same result is achieved if the reaction is performed with sodium hypochlorite in the presence of a di-tert.-alkylnitrooxyl compound, such as 2,2,6,6-tetramethylpiperidine-1-oxyl (WO 95/107303).

The C2-C3 glycoside bond may be oxidized by reacting starch with hypobromite according to EP 427 349 A1, resulting in the formation of polydicarboxysaccharides, which can be used as phosphate substitutes in detergents. According to WO 94/21690, the vicinal diol grouping of starch may also be cleaved by oxidation with hydrogen peroxide in the presence of a catalytic quantity of an alkali metal halide and be converted into carboxyl groups.

Starch may also be converted into a carbonyl-substituted starch, “dialdehyde starch”, by oxidation with periodate in an aqueous medium. 30-85% of the available diol groupings may be converted into aldehyde groupings. Periodate may be recovered by an electrochemical process and reused. The high level of technical complexity of this process is disadvantageous.

According to the process of U.S. Pat. No. 3,553,193, starch may be oxidized using a mixture of sodium hypobromite and sodium bromite, wherein a carbonyl group-substituted starch is obtained which, apart from the carbonyl groups (=aldehyde groups), also contains a small proportion of carboxyl groups. The degree of carbonyl substitution is in the range from 0.01 to 0.5 and the ratio of carbonyl groups to carboxyl groups is in the range from 2-8: approx. 1. The disadvantage of this process is the requirement to use a costly oxidizing agent system. In addition, the salt content of the waste water is increased.

The waste water contamination disadvantages of the above-stated process may be reduced according to U.S. Pat. No. 3,975,206 if starch is oxidized in granular form with hydrogen peroxide in the presence of a metal ion catalyst in an aqueous suspension. The aim of the process disclosed in said document is to degrade the starch, wherein the oxidatively degraded starch exhibits properties which characterize both acidically hydrolyzed starches and oxidized starches. Said document provides no indication of the carbonyl and/or carboxyl content of the starches oxidized according to the process.

P. Parovuori, et al. (Starch/Stärke 47 (1995) no. 1, pages 19-23) carried out a thorough investigation of the oxidation of potato starch with hydrogen peroxide in the presence of copper, iron and tungsten catalysts. In this oxidation, carbonyl groups and, to a lesser extent, carboxyl groups are introduced into the starch molecule. In the process here disclosed, starch is also oxidized in an aqueous suspension with a solids content of 42% with 2% of hydrogen peroxide under alkaline or acidic conditions in the presence of 0.1% of metal ions, relative to dried starch. Starch oxidized under alkaline conditions contained at most 6.4 carbonyl groups and 0.9 carboxyl groups per 100 glucose units. Under acidic reaction conditions, the oxidized starch contained at most 8.6 carbonyl and 1.6 carboxyl groups per 100 glucose units. The disadvantage of this process is that the reaction proceeds in an aqueous suspension, as a result of which degradation products may enter the waste water, resulting in losses of yield. If the above-stated degree of oxidation is to be achieved with acidic oxidation, a long reaction time of 24 h is required according to the examples. Said document contains no indication of whether and in what manner the properties of the oxidized starch may be modified by the input quantity of catalyst and of hydrogen peroxide.

An object of the present invention is accordingly to improve the above-acknowledged generic process for the oxidation of starch to obtain carbonyl-substituted starch. In particular, the intention was to ensure the highest possible carbonyl content of the starch while using the smallest possible quantity of hydrogen peroxide and of catalytically active metal ions. A further intention was to shorten the reaction time.

### SUMMARY OF THE INVENTION

The above-stated objects, together with further objects revealed in the following description of the invention, can be achieved by the process according to the invention.

A process has been found for the oxidation of starch to obtain carbonyl-substituted starch, said process comprising treating the starch with hydrogen peroxide in the presence of a metal ion catalyst of elements selected from the group consisting of vanadium, chromium, manganese, iron, cobalt, copper, molybdenum, tungsten and mixtures thereof, at a temperature below the gelatinization temperature of the starting and substituted starch, characterized in that oxidation is performed without converting the starch into an aqueous suspension by uniformly spraying the starch in a pulverulent state once or repeatedly with an aqueous hydrogen peroxide solution and an aqueous solution containing catalyst or with an aqueous solution containing hydrogen peroxide and catalyst and allowing the sprayed starch to post-react.

Starches from the most varied types of cereals. tuber starches and legume starch are amenable to the process according to the invention. The starch from wheat, oats, rye, barley, rice, maize, potatoes, sago, tapioca, sorghum and various pulses may be stated by way of example. Chemically modified starches, such as esterified and etherified starches, as well as starches comprising cationic or anionic substituents may also be used.

The feature of the process which is essential to the invention is that, unlike in the prior art, the starch to be oxidized is not converted into an aqueous suspension. Instead, the pulverulent starch is sprayed for the purpose of oxidation with a hydrogen peroxide solution and a solution containing catalyst, wherein the moistened powder is homogenized during and/or after spraying. It is also possible to mix the hydrogen peroxide solution and the catalyst solution immediately before use thereof and to spray them onto the starch as a mixture. In the latter-stated embodiment, it should be noted that hydrogen peroxide may be subject to partial catalytic decomposition by the metal catalysts before the desired reaction. The oxidation according to the invention proceeds in “quasi-dry” form. This is taken to mean that the starch is introduced in dry form and the starch which has been sprayed with the aqueous reactants is still in the form of a moist powder. The total moisture content arises from the moisture of the introduced starch (conventionally 8-12%) together with the water introduced with the solution and the water of reaction. The total moisture content of the moist powder is conveniently below 70 wt. %, preferably below 55 wt. % and in particular in the range from 20 to 50 wt. %.

### DETAILED DESCRIPTION OF INVENTION

Thanks to the quasi-dry process according to the invention, it is possible to obtain carbonyl-substituted starch with a higher carbonyl content than has been possible in prior art processes. According to the invention, it is possible to obtain an oxidized starch which contains approx. 10 aldehyde groups per 100 glucose units. Another advantage of the process is that the elevated carbonyl content is obtainable with a small input quantity of hydrogen peroxide and a smaller input quantity of catalysts than in the prior art process. Moreover, the reaction or post-reaction time required to achieve an elevated carbonyl content is substantially shorter than in the prior art process. Finally, a device for controlling the temperature of the reaction mixture is not required in the process according to the invention. Due to the small quantity of catalyst of the optimized embodiments, it is possible to dispense with catalyst removal for some applications or removal may be performed only after subsequent process stages.

Hydrogen peroxide is used in the process according to the invention as an aqueous solution, which may contain known stabilizers. The aqueous hydrogen peroxide solution preferably exhibits a weakly acidic pH value. The H₂O₂ content of the solution is conveniently in the range from 10-50 wt. %, but lower or higher concentrations may also be used. The H₂O₂ content of the hydrogen peroxide solution to be sprayed is particularly preferably in the range from 20 to 40 wt. %, in particular approx. 30 to 35 wt. %.

The input quantity of hydrogen pet-oxide, relative to 100 glucose units of the starch to be oxidized, is substantially determined by the desired degree of oxidation and in particular by the desired carbonyl content. The input quantity is conventionally in the range of 1-1000 mmol of H₂O₂ per glucose unit, preferably in the range 50-500 mmol of H₂O₂ and particularly preferably in the range 100-300 mmol of H₂O₂ per glucose unit of the starch.

Metal compounds of the elements selected from the group consisting of vanadium, chromium, manganese, iron, cobalt, copper, molybdenum, tungsten and mixtures thereof are catalytically active. The catalytically active species comprise metal cations of the elements selected from the group consisting of Mn, Fe, Co and Cu or oxo anions of the elements V, Cr, Mo and W. Compounds of copper and/or iron are preferred with regard to obtaining the highest possible carbonyl content. Copper or a combination of copper and iron are very particularly active. In the process according to the invention, the catalytically active metals are used in the form of compounds of these metals, wherein the compounds preferably comprise water-soluble compounds of the metals. In the case of the preferred metals copper and/or iron, these metals are preferably used in the form of a sulfate, nitrate or acetate; metal chlorides are generally less preferred with regard to increased formation of carbonyl groups (c.f. WO 94/2169).

The input quantity of catalytically active metals is dependent upon the selection of a single catalyst or a combination of catalysts. The catalyst is conveniently used in a quantity of up to 1000 mg of active metal per kg of starch. Catalyst content, calculated as metal, is preferably below 1000 mg, in particular in the range from 100-700 mg per kg of starch.

It has been found that, in order to produce an oxidized starch with a specific carbonyl content, the input quantity of hydrogen peroxide may be reduced if the input quantity of catalyst is increased. Correspondingly, the input quantity of catalyst may be reduced if the input quantity of hydrogen peroxide is increased. It has furthermore been established that, at a given input quantity of catalyst, above a value of approx. 10 carbonyl groups per 100 glucose units, carbonyl content cannot be raised appreciably further by increasing the input quantity of H₂O₂, but under such conditions the carboxyl content rises and the ratio of carbonyl content to carboxyl content falls.

The process according to the invention may be performed in any desired apparatus which permits spraying of the necessary aqueous solutions and homogeneous mixing of the moistened starch. The starch may, for example, be sprayed in an open trough with occasional mixing. The aqueous solutions are preferably sprayed onto the starch to be oxidized in a powder mixing apparatus, for example a tumble mixer. The post-reaction may also be performed in such a mixer. Another alternative is to spray the hydrogen peroxide solution and the catalyst solution into a fluidized bed of the starch to be oxidized. The solutions may be injected continuously or intermittently. Once addition is complete or, in the case of intermittent addition, after each period of addition, it is convenient to leave the mixture to post-react in homogeneous distribution. Post-reaction time is conveniently in the range from 0.2 to 2 h. Apparatus known to the person skilled in the art, such as single or multi-fluid nozzles, is suitable for spraying the starch. Where the catalyst solution and hydrogen peroxide solution are sprayed by means of a single nozzle, it is convenient to use a 3- or 4-fluid nozzle with an external mixing zone, as a result of which the hydrogen peroxide is in contact with the catalytically active metal compounds for only a very short period before striking the starch particles.

One advantage of the process according to the invention is that the reaction may be performed at room temperature or slightly above, thus in practice at a temperature in the range from 10 to approx. 40° C. and no additional facilities are required to control the temperature of the reaction mixture.

Where necessary with regard to the subsequent use of the oxidized starch, the metal ion catalyst may be separated from the oxidized starch by a conventional washing process with water. Since the oxidation according to the invention results in the formation of substantially no low molecular weight and thus water-soluble starch degradation products, yield is virtually quantitative even when the stated post-cleaning is performed.

The invention is further illustrated by means of the following Comparative Examples and Examples according to the invention.

### COMPARATIVE EXAMPLES (VB)

116.5 g of starch (=100 g of dry starch) were suspended in 207.9 g of H₂O (adjusted to pH 5 with H₂SO₄) in a 0.5 L jacketed reaction vessel. The suspension was heated to 40° C. The catalyst was dissolved in 50 ml of H₂O (pH 5) and added at 40° C. with vigorous stinging in five portions at 30 minute intervals. One fifth of the quantity of H₂O₂ was simultaneously apportioned in each case. The suspension was stirred for one hour further after the final addition. The pH value of the reaction solution was maintained at pH 5 during the reaction by addition of 0.5 n NaOH and, at the end of the reaction, adjusted to pH 6. The temperature was then allowed to drop to approx. 30° C., then the product was filtered out and the filter cake washed free of salt with 1500 ml of water. The product was dried in air at room temperature (RT). The input quantity of H₂O₂ and catalyst and the results are shown in the table.

### EXAMPLES B1 to B5

The catalyst is dissolved by stirring in 40 g of deionized water. The catalyst solution(s) were prepared using CuSO₄.5H₂O or FeSO₄.7H₂O. The catalyst solution was then transferred into a tared spray bottle. In parallel, the necessary quantity of 30% H₂O₂ was also placed in a separate, tared spray bottle.

For the reaction, 600 mmol of a native starch (Raisamyl) were weighed out in the quasi-dry state (residual moisture content 8-14%) into a temperature-controlled stainless steel trough and uniformly distributed. At a constant temperature, half the catalyst solution and half the H₂O₂ solution were uniformly applied at One hour intervals onto the starch and the moistened starch was thoroughly mixed. The starch was thoroughly remixed at 15 minute intervals. The starch was left to post-react for one hour further after the final addition. The catalyst was separated by suspending the oxidized starch in 500 ml of water, filtering it and rewashing the cake of starch. The product was dried in air.

The input quantity of H₂O₂ per 100 g of starch, the input quantity of catalyst (mg of metal per 100 g of starch), the yield (after washing) and carboxyl and carbonyl contents are shown in the table.

TABLE

| | | Cu²⁺ | Fe²⁺ | | |
|---|---|---|---|---|---|
| Example | H₂O₂ | [mg/kg | [mg/kg | Yield | Carboxyl content |
| no. | [mmol] | starch*⁾] | starch*⁾] | [%] | [mmol/g**⁾] |
| VB | 120 | 390 | 336 | 84.1 | 0.0472 |
| B1 | 120 | 390 | 336 | 98.1 | 0.0725 |
| B2 | 60 | 390 | 336 | 98.8 | 0.0249 |
| B3 | 180 | 390 | 336 | 97.6 | 0.0903 |
| B4 | 120 | 195 | — | 98.5 | 0.0101 |
| B5 | 60 | 390 | — | 98.8 | 0.0093 |

*⁾dry starch
**⁾dry oxidised starch

The results show that a higher yield is achieved according to the invention. With a reduced input quantity of H₂O₂, a distinctly higher carbonyl content is achieved in comparison with VB (comparison of B2 with VB). With a smaller quantity of catalyst than in VB, a higher carbonyl content is achieved, c.f. VB and B4.

The starches produced by the process described herein can be used for all the purposes known in the art for such starches.

Further modifications and variations of the foregoing will now be apparent to those skilled in the art and are intended to be encompassed by the claims appended hereto.

German priority application 101 46 069.4 of Sep. 19, 2001 is relied on and incorporated herein by reference.

We claim:

1. A process for the oxidation of starch to obtain carbonyl-substituted starch comprising oxidizing starch by treating the starch by uniformly spraying the starch in a pulverulent state at least once with an aqueous hydrogen peroxide solution and an aqueous solution containing catalyst or with an aqueous solution containing hydrogen peroxide and catalyst, wherein the catalyst is a metal ion catalyst of an element selected from the group consisting of vanadium, chromium, manganese, iron, cobalt, copper, molybdenum, tungsten and mixtures thereof, at a temperature below the gelatinization temperature of the starch, and allowing the sprayed starch to post-react.

2. The process according to claim 1, wherein said catalyst is a water-soluble compound of copper and/or iron.

3. The process according to claim 1, wherein the catalyst is up to 1000 mg of catalytically active metals per kg of starch.

4. The process according to claim 2, wherein the catalyst is up to 1000 mg of catalytically active metals per kg of starch.

5. The process according to claim 1, wherein the catalyst is 100 to 700 mg of catalytically active metals per kg of starch.

6. The process according to claim 2, wherein the catalyst is 100 to 700 mg of catalytically active metals per kg of starch.

7. The process according to claim 1, wherein hydrogen peroxide is present in a quantity of 10 to 1000 mmol, per glucose unit of the starch.

8. The process according to claim 2, wherein hydrogen peroxide is present in a quantity of 10 to 1000 mmol, per glucose unit of the starch.

9. The process according to claim 3, wherein hydrogen peroxide is present in a quantity of 10 to 1000 mmol, per glucose unit of the starch.

10. The process according to claim 1, wherein hydrogen peroxide is used in a quantity of 50 to 500 mmol per glucose unit of the starch.

11. The process according to claim 2, wherein hydrogen peroxide is used in a quantity of 50 to 500 mmol per glucose unit of the starch.

12. The process according to claim 3, wherein hydrogen peroxide is used in a quantity of 50 to 500 mmol per glucose unit of the starch.

13. The process according to claim 1, wherein 50 to 200 mmol of hydrogen peroxide are used per glucose unit of the starch.

14. The process according to claim 2, wherein 50 to 200 mmol of hydrogen peroxide are used per glucose unit of the starch.

15. The process according to claim 3, wherein 50 to 200 mmol of hydrogen peroxide are used per glucose unit of the starch.

16. The process according to claim 10, wherein 50 to 200 mmol of hydrogen peroxide are used per glucose unit of the starch.

17. The process according to claim 1, wherein hydrogen peroxide is used in the form of a 10 to 50 wt. % aqueous solution.

18. The process according to claim 2, wherein hydrogen peroxide is used in the form of a 10 to 50 wt. % aqueous solution.

19. The process according to claim 3, wherein hydrogen peroxide is used in the form of a 10 to 50 wt. % aqueous solution.

20. The process according to claim 10, wherein hydrogen peroxide is used in the form of a 10 to 50 wt. % aqueous solution.

21. The process according to claim 13, wherein hydrogen peroxide is used in the form of a 10 to 50 wt. % aqueous solution.

22. The process according to claim 1, further comprising spraying the starch continuously or intermittently in a mixer or in a fluidized bed with said aqueous hydrogen peroxide solution and said catalyst solution by means of separate spray nozzles or by means of a 3- or 4-fluid nozzle with external mixing.

23. The process according to claim 2, further comprising spraying the starch continuously or intermittently in a mixer or in a fluidized bed with said aqueous hydrogen peroxide solution and said catalyst solution by means of separate spray nozzles or by means of a 3- or 4-fluid nozzle with external mixing.

24. The process according to claim 3, further comprising spraying the starch continuously or intermittently in a mixer or in a fluidized bed with said aqueous hydrogen peroxide solution and said catalyst solution by means of separate spray nozzles or by means of a 3- or 4-fluid nozzle with external mixing.

25. The process according to claim 10, further comprising spraying the starch continuously or intermittently in a mixer or in a fluidized bed with said aqueous hydrogen peroxide solution and said catalyst solution by means of separate spray nozzles or by means of a 3- or 4-fluid nozzle with external mixing.

26. The process according to claim 13, further comprising spraying the starch continuously or intermittently in a mixer or in a fluidized bed with said aqueous hydrogen peroxide solution and said catalyst solution by means of separate spray nozzles or by means of a 3- or 4-fluid nozzle with external mixing.

27. The process according to claim 1, further comprising oxidizing at a temperature in the range from 10 to 40° C. and, before further processing or cleaning, and allowing the starch which has been sprayed with catalyst and hydrogen peroxide to post-react at 10 to 40° C. for 0.2 to 2 hours.

28. The process according to claim 2, further comprising oxidizing at a temperature in the range from 10 to 40° C. and, before further processing or cleaning, and allowing the starch which has been sprayed with catalyst and hydrogen peroxide to post-react at 10 to 40° C. for 0.2 to 2 hours.

29. The process according to claim 1, further comprising during and/or after spraying with the solution containing H₂O₂ and/or catalyst, homogeneously distributing the starch and, after an effective post reaction time, post-cleaning the pulverulent, moist reaction mixture by washing out the catalyst with water.

30. The process according to claim 2, further comprising during and/or after spraying with the solution containing H₂O₂ and/or catalyst, homogeneously distributing the starch and, after an effective post-reaction time, post-cleaning the pulverulent moist reaction mixture by washing out the catalyst with water.

31. The process according to claim 1, wherein the total moisture content of the starch after spraying is less than 70 wt. %.

32. The process according to claim 1, wherein the total moisture content of the starch after spraying is less than 55 wt. %.

33. An oxidized starch produced by the process of claim 1.

34. The oxidized starch according to claim 33 which has about 10 aldehyde groups per 100 glucose units.
